(19) United States
(12) Patent Application Publication
(10) Pub. No.: US 2018/0257304 A1
(43) Pub. Date: Sep. 13, 2018

(54) FABRICATION MANAGEMENT SYSTEM AND FABRICATION MANAGEMENT CONTROL APPARATUS

(71) Applicant: FUJI XEROX CO., LTD., Tokyo (JP)

(72) Inventors: Hiroshi HAGIWARA, Kanagawa (JP); Satoshi TOMITA, Kanagawa (JP); Kazunori ONISHI, Kanagawa (JP)

(73) Assignee: FUJI XEROX CO., LTD., Tokyo (JP)

(21) Appl. No.: 15/698,953

(22) Filed: Sep. 8, 2017

(30) Foreign Application Priority Data
Mar. 7, 2017 (JP) 2017-042835

(51) Int. Cl. B29C 64/393; B29C 64/20; B33Y 30/00; B33Y 50/02

(52) U.S. Cl. CPC B29C 64/393; B33Y 50/02; B33Y 30/00; B29C 64/20

(57) ABSTRACT

A fabrication management system includes a fabrication control apparatus and a fabrication management server. The fabrication control apparatus includes a composite fabrication unit that fabricates a fabricated component over a previously fabricated component to fabricate a finished fabricated object, and a controller that controls fabrication performed by the composite fabrication unit. The fabrication management server includes an instructing section that, by use of fabrication information about each of multiple fabricated components to be assembled into the finished fabricated object and positional information identifying a position onto which each fabricated component is assembled upon completion of the finished fabricated object, instructs fabrication to be performed by using the composite fabrication unit in accordance with fabrication procedure information used to sequentially perform fabrication in the height direction.

### CROSS-REFERENCE TO RELATED APPLICATIONS

This application is based on and claims priority under 35 USC 119 from Japanese Patent Application No. 2017-042835 filed Mar. 7, 2017.

### BACKGROUND

### Technical Field

The present invention relates to a fabrication management system, and a fabrication management control apparatus.

### SUMMARY

According to an aspect of the invention, there is provided a fabrication management system including a fabrication control apparatus and a fabrication management server. The fabrication control apparatus includes a composite fabrication unit that fabricates a fabricated component over a previously fabricated component to fabricate a finished fabricated object, and a controller that controls fabrication performed by the composite fabrication unit. The fabrication management server includes an instructing section that, by use of fabrication information about each of multiple fabricated components to be assembled into the finished fabricated object and positional information identifying a position onto which each fabricated component is assembled upon completion of the finished fabricated object, instructs fabrication to be performed by using the composite fabrication unit in accordance with fabrication procedure information used to sequentially perform fabrication in the height direction.

### BRIEF DESCRIPTION OF THE DRAWINGS

Exemplary embodiment of the present invention will be described in detail based on the following figures, wherein:

FIG. 1 schematically illustrates an overview of a fabrication management system according to an exemplary embodiment;

FIG. 2 is a block diagram illustrating a configuration of a fabrication-order-receipt management control apparatus according to the exemplary embodiment;

FIGS. 3A to 3G each schematically illustrate a three-dimensional fabricator that may be employed for the exemplary embodiment;

FIG. 4A is a front view of a composite fabrication unit according to the exemplary embodiment;

FIG. 4B is a perspective view of the composite fabrication unit illustrated in FIG. 4A;

FIG. 5 is a cross-sectional view of a three-dimensional fabricated object fabricated from multiple materials that exist in the same plane with respect to the height direction;

FIG. 6 is a functional block diagram according to the exemplary embodiment, illustrating in detail a process for executing a fabrication-order-receipt management control;

FIG. 7 is a flowchart illustrating a fabrication-order-receipt management control routine according to the exemplary embodiment;

FIG. 8A is a plan view, according to Modification 1 of the exemplary embodiment, of a composite fabrication system for when a rotary table is used to transport components;

FIG. 8B is a front view, according to Modification 1 of the exemplary embodiment, of the composite fabrication system illustrated in FIG. 8A; and

FIG. 9 is a front view, according to Modification 2 of the exemplary embodiment, of a structure in which a table is held stationary and three-dimensional fabricators are moved.

### DETAILED DESCRIPTION

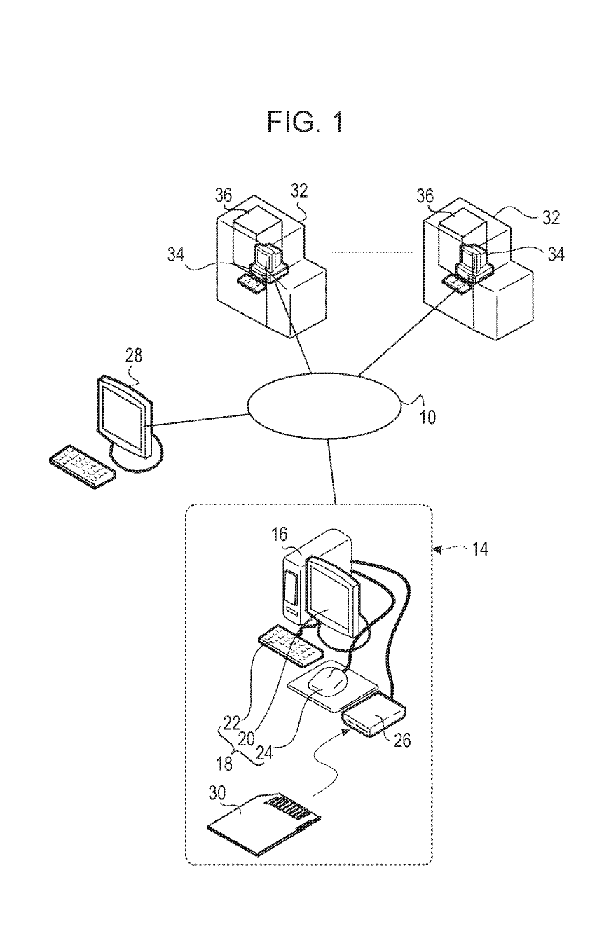

FIG. 1 schematically illustrates an overview of a fabrication management system including a fabrication-order-receipt management control apparatus 14 serving as a fabrication management server according to an exemplary embodiment.

A communication network 10 is connected with the fabrication-order-receipt management control apparatus 14. The communication network 10 is, for example, a local area network (LAN) or an Internet network. The communication network 10 may include multiple LANs connected by a wide area network (WAN). Not all the communication networks including the communication network 10 need to be wired networks. That is, some or all of the communication networks may be wireless communication networks that transmit and receive information by radio.

The fabrication-order-receipt management control apparatus 14 has a body 16, and a user interface (UI) 18. The UI 18 includes a monitor 20 serving as a display, and a keyboard 22 and a mouse 24 each serving as an input operation unit.

The body 16 is connected with a media reader 26 that functions as an input source for ordering information required for placing a fabrication order.

The media reader 26 is provided with a slot that allows insertion of a recording medium 30 such as an SD memory. Ordering information recorded on the inserted recording medium is read and sent to the body 16.

Ordering information may be received from a PC 28 used for placing an order (to be sometimes also referred to as “ordering PC 28” hereinafter), which is connected to the communication network 10 and owned by the orderer. Although FIG. 1 depicts a single PC 28, the communication network 10 may be connected with multiple PCs 28.

The communication network 10 is connected with a control apparatus 34 that serves as a fabrication control apparatus owned by each of fabricated object manufacturers 32 that fabricate three-dimensional fabricated objects.

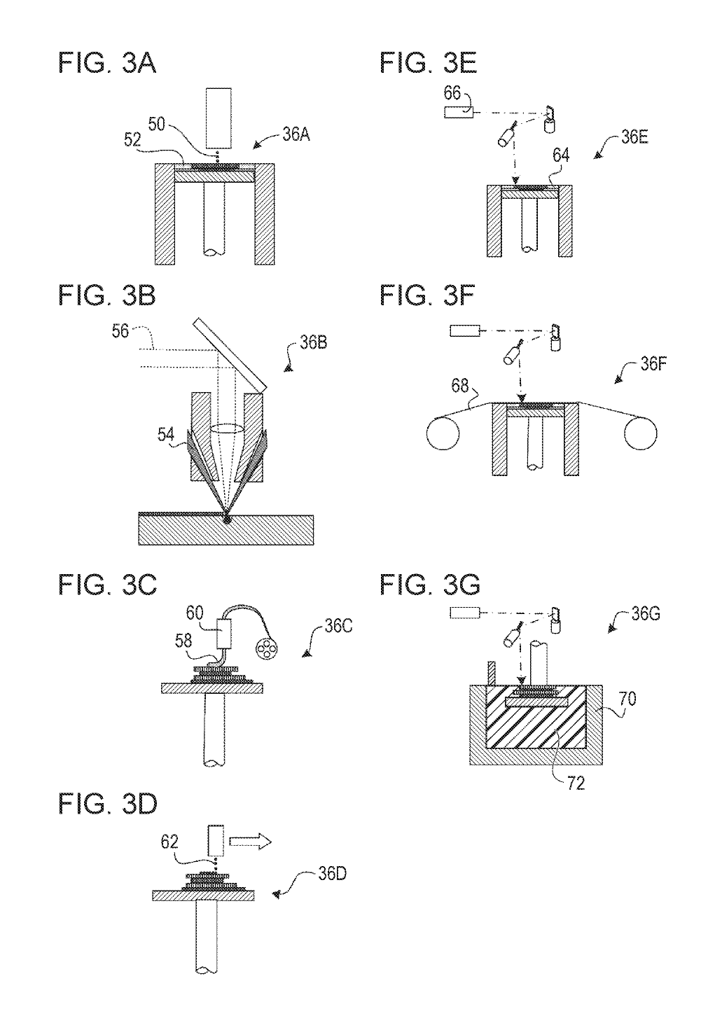

The control apparatus 34 manages multiple three-dimensional fabricators 36 (see FIGS. 3A to 3G) owned by individual fabricated object manufacturers 32. Although FIG. 1 depicts two fabricated object manufacturers 32 and their associated control apparatuses 34, the number of fabricated object manufacturers may be one, or three or more.

The fabricated object manufacturers 32 include multiple three-dimensional fabricators 36 (see FIGS. 3A to 3G), which are distinguished from each other according to the fabrication method employed (see three-dimensional fabricators 36A to 36G respectively illustrated in FIGS. 3A to 3G). When the three-dimensional fabricators 36 are to be generically referred to without regard to their fabrication method, each three-dimensional fabricator 36 will be referred to as “three-dimensional fabricator 36” or “3D printer 36”.

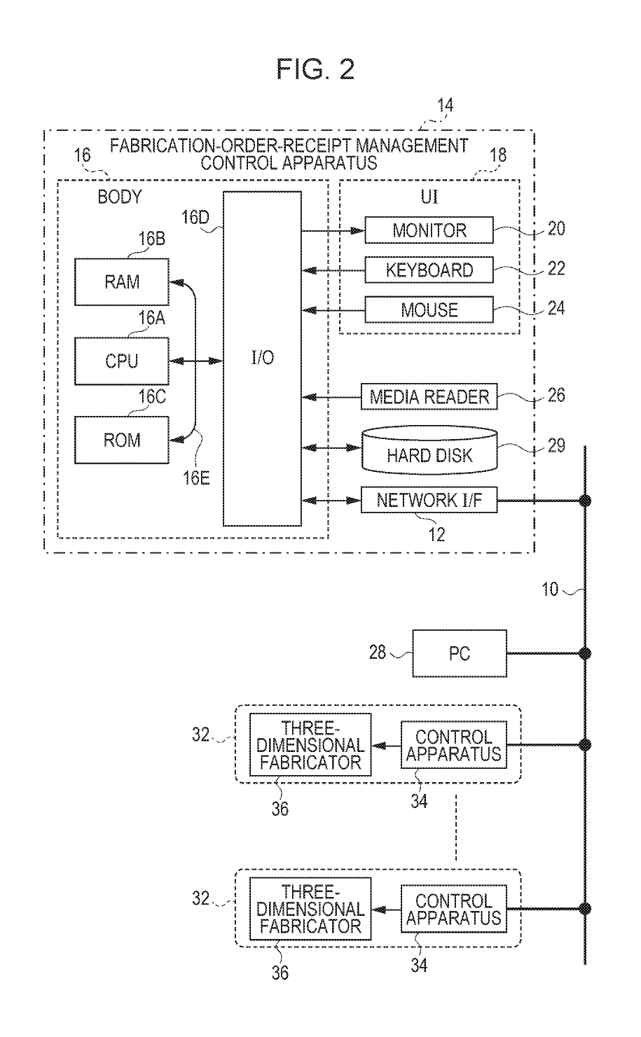

As illustrated in FIG. 2, the body 16 of the fabrication-order-receipt management control apparatus 14 includes a CPU 16A, a RAM 16B, a ROM 16C, an input/output unit 16D (I/O 16D), and a bus 16E that connect these components, such as a data bus or a control bus.

The I/O 16D is connected with a network I/F 12 that enables communication with the communication network 10, the UI 18 (the monitor 20, the keyboard 22, and the mouse 24), and the media reader 26.

The I/O 16D is also connected with a hard disk 29 serving as a large-scale recording medium. The hard disk 29 temporarily stores order-receipt management information related to a received fabrication order.

The ROM 16C stores a program for executing a fabrication-order-receipt management control. Upon activation of the fabrication-order-receipt management control apparatus 14, the program is read from the ROM 16C and executed by the CPU 16A. The fabrication-order-receipt management control program may be recorded on, other than the ROM 16C, the hard disk 29 or other recording media.

In the exemplary embodiment, the fabricated object manufacturers have multiple kinds of three-dimensional fabricators 36 that employ different fabrication methods.

Examples of fabrication methods include binder jetting, directed energy deposition, material extrusion, material jetting, powder bed fusion, sheet lamination, and vat photopolymerization.

FIGS. 3A to 3G illustrate an exemplary relationship between the type and function of each fabrication method, and the material that is compatible with each fabrication method.

### (1) Binder Jetting

As illustrated in FIG. 3A, binder jetting employed by the three-dimensional fabricator 36A is a method with which a binder 50 in liquid form is jetted onto a powder bed 52 to selectively solidify the binder 50. Examples of materials used for this method include gypsum, ceramics, sand, calcium, and plastics.

### (2) Directed Energy Deposition

As illustrated in FIG. 3B, directed energy deposition employed by the three-dimensional fabricator 36B is a method with which, while a material 54 is fed, a beam 56 or other form of radiation is focused to control the location of heat generation for selective melting and fusing of the material 54. Examples of materials used for this method include metals.

### (3) Material Extrusion

As illustrated in FIG. 3C, material extrusion employed by the three-dimensional fabricator 36C is a method with which a flowable material 58 is extruded from a nozzle 60 and solidified simultaneously with its deposition. Examples of materials used for this method include acrylonitrile butadiene styrene (ABS), polylactic acid (PLA), Nylon 12, polycarbonate (PC), and polyphenylsulfone (PPSF).

### (4) Material Jetting

As illustrated in FIG. 3D, material jetting employed by the three-dimensional fabricator 36D is a method with which droplets 62 of material are jetted and selectively deposited and solidified. The three-dimensional fabricator 36D performs fabrication by using an inkjet method, which is a representative example of the material jetting method. Examples of materials used for this method include UV-curable resin, fat, wax, and solder.

### (5) Powder Bed Fusion

As illustrated in FIG. 3E, powder bed fusion employed by the three-dimensional fabricator 36E is a method with which a region 64 on which a layer of powder is laid is subjected to thermal energy radiated from a laser 66 to selectively melt and fuse the layer of powder. Examples of materials used for this method include engineering plastics, nylon, and metals.

### (6) Sheet Lamination

As illustrated in FIG. 3F, sheet lamination employed by the three-dimensional fabricator 36F is a method with which sheets of material 68 are bonded. Examples of materials used for this method include paper, resin sheets, and aluminum sheets.

### (7) Vat Photopolymerization

As illustrated in FIG. 3G, vat photopolymerization employed by the three-dimensional fabricator 36G is a method with which photo-curable resin 72 in liquid form stored in a tank 70 is selectively cured by photopolymerization. Examples of materials used for this method include UV-curable resin.

The seven three-dimensional fabricators 36A to 36G employing different fabrication methods described in (1) to (7) above are selectively owned by fabricated object manufacturers. Although FIGS. 3A to 3G illustrate fabrication methods described in (1) to (7) above, three-dimensional fabricators employing fabrication methods different from those described in (1) to (7) may be used.

When the fabrication-order-receipt management control apparatus 14 receives a fabrication request for a three-dimensional fabricated object from an orderer, the fabrication-order-receipt management control apparatus 14 selects a fabrication method.

The fabrication-order-receipt management control apparatus 14 stores, on the hard disk 29 (see FIG. 2), the relationship (a material/fabrication-method compatibility table) between individual materials and the fabrication methods (the three-dimensional fabricators described with reference to (1) to (7) above) compatible with these materials. For example, when a material is specified from the orderer, the fabrication-order-receipt management control apparatus 14 reads the material/fabrication-method compatibility table to select a compatible fabrication method.

The fabrication-order-receipt management control apparatus 14 determines which fabricated object manufacturer 32 owns the three-dimensional fabricator 36 that employs the selected fabrication method, and places a fabrication order with the control apparatus 34 managed by the corresponding fabricated object manufacturer 32.

When the control apparatus 34 of the fabricated object manufacturer 32 receives a fabrication request (including fabrication data, fabrication method, and the material used) for a three-dimensional fabricated object, the fabricated object manufacturer 32 fabricates the three-dimensional fabricated object by use of the three-dimensional fabricator 36. In some instances, the conditions used by the fabrication-order-receipt management control apparatus 14 to select a fabricated object manufacturer include delivery time and cost.

In some instances, the content of a received order (order sheet information) represents a request for fabrication of three-dimensional fabricated objects made from multiple different materials and assembled with each other into a finished object (composite fabricated object). In other words, the individual three-dimensional fabricated objects constituting the finished fabricated object and fabricated from multiple different materials are to be regarded as components of the finished fabricated object.

Three-dimensional fabricated objects (components) made from different materials are generally fabricated as follows. Basically, the three-dimensional fabricators 36 that employ different fabrication methods are selected to fabricate such components individually through separate processes, and then the fabricated components are assembled together at the orderer into a finished fabricated object.

In this case, assembly accuracy needs to be taken into account. Accordingly, such a fabrication process often requires a fabrication accuracy higher than that required for fabrication of a three-dimensional fabricated object made from a single material.

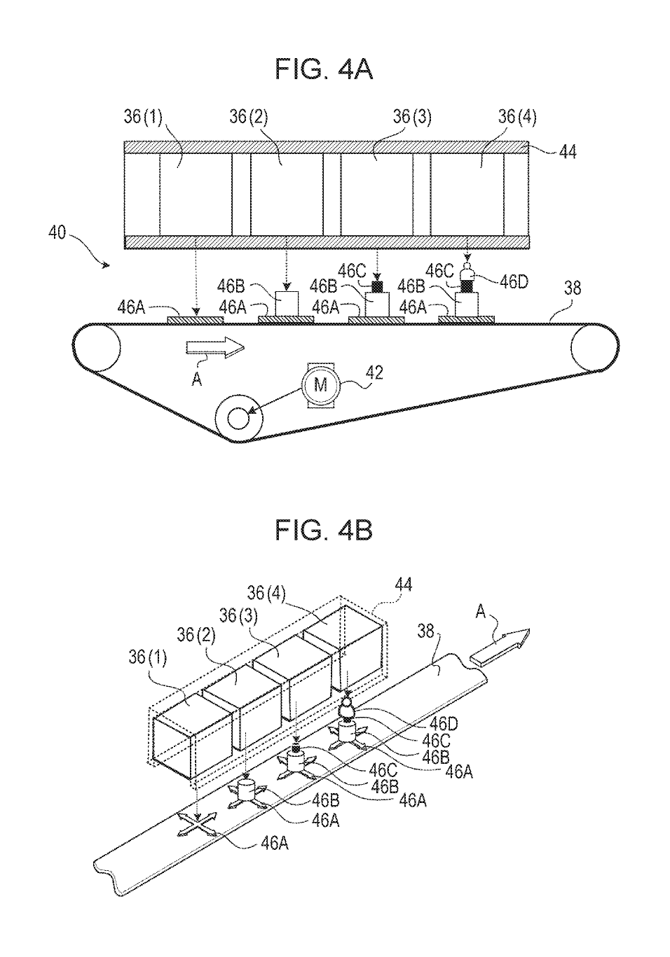

For example, as illustrated in FIGS. 4A and 4B, at least one fabricated object manufacturer 32 includes a composite fabrication unit 40. The composite fabrication unit 40 includes a moving table (a belt conveyor 38) that sequentially moves between multiple three-dimensional fabricators 36 employing different fabrication methods.

As illustrated in FIG. 4A, the composite fabrication unit 40 includes the belt conveyor 38 (moving table) that serves as a reference plane during the fabrication process. The belt conveyor 38 is capable of moving (in the direction of an arrow A in FIG. 4A or in a direction opposite to this direction) with the driving force provided by a motor 42.

Multiple three-dimensional fabricators 36 employing different fabrication methods are arranged in the direction of movement of the belt conveyor 38, and attached to a head holder 44. As a result, as the belt conveyor 38 moves, an already-fabricated component may be transported between the three-dimensional fabricators 36 employing different fabrication methods. This enables additional fabrication to be performed based on the already-fabricated component.

In this case, the three-dimensional fabricators 36 employing different fabrication methods that are to be attached to the head holder 44 are changed at the time of order receipt in accordance with each fabrication method required. This enhances general versatility in comparison to when a fixed set of three-dimensional fabricators 36 employing different fabrication methods is attached to the head holder 44.

The composite fabrication unit 40 employs a basic fabrication procedure described below. That is, while the belt conveyor 38 is sequentially moved in a one-way direction as indicated by the arrow A in FIGS. 4A and 4B to a position facing each three-dimensional fabricator 36, a new three-dimensional fabricated object is fabricated on top of a three-dimensional fabricated object that has been previously fabricated.

Some composite fabrication processes involve, rather than simply layering different three-dimensional fabricated objects on top of each other sequentially, fabricating three-dimensional fabricated objects while selecting different three-dimensional fabricators 36 in a complex manner.

For example, FIGS. 4A and 4B illustrate a basic procedure for composite fabrication performed by the composite fabrication unit 40. The basic procedure includes fabricating a first component 46A by use of a first three-dimensional fabricator 36 (1), following by moving the belt conveyor 38 in the direction of the arrow A to fabricate a second component 46B by use of a second three-dimensional fabricator 36 (2), followed by moving the belt conveyor 38 in the direction of the arrow A to fabricate a third component 46C by use of a third three-dimensional fabricator 36 (3), and then followed by moving the belt conveyor 38 in the direction of the arrow A to fabricate a fourth component 46D by use of a fourth three-dimensional fabricator 36 (4).

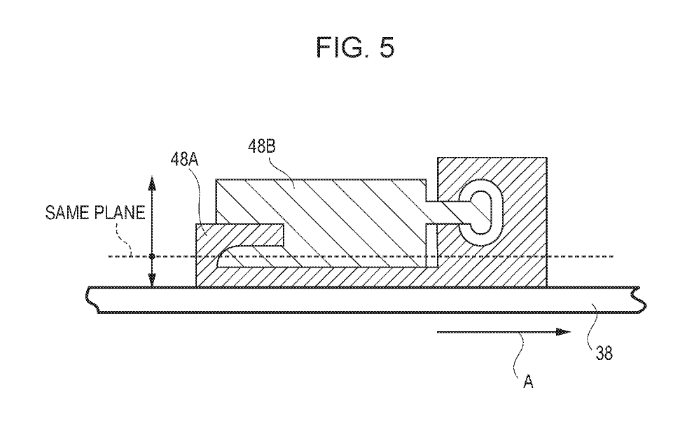

In contrast, FIG. 5 illustrates a process that requires a component 48A and a component 48B to be fabricated alternately in the same plane (the same plane in which fabrication takes place at the same time) with respect to the height direction. In this case, it is necessary to know beforehand through what procedure the movement of the belt conveyor 38 is to be controlled and which three-dimensional fabricator 36 is to be operated in the composite fabrication unit 40. That is, in some instances, fabrication may not be accomplished by simply moving the belt conveyor 38 in a one-way direction indicated by the arrow A.

Accordingly, with the exemplary embodiment, an operation process (fabrication workflows) is developed by also taking into account how components are assembled with each other, and when the orderer passes an order for composite fabrication to a fabricated object manufacturer, the orderer attaches the fabrication workflows to the placed order.

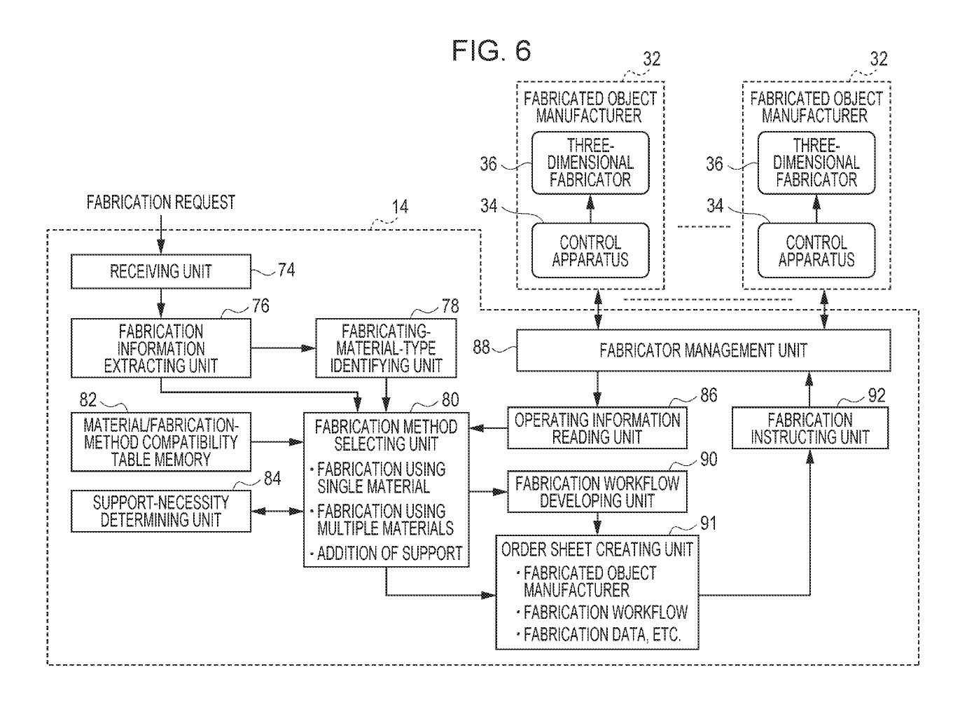

FIG. 6 illustrates functional blocks for executing a fabrication-order-receipt management control according to the exemplary embodiment, which is executed by the fabrication-order-receipt management control apparatus 14 (see FIG. 2) to provide a finished three-dimensional fabricated object through composite fabrication involving assembly of multiple components that are requested to be fabricated by using different materials. The blocks illustrated in FIG. 6 are not intended to limit the hardware configuration of the fabrication-order-receipt management control apparatus 14.

Although the fabrication-order-receipt management control apparatus 14 has the function of receiving a fabrication request including not only composite fabrication but also fabrication using a single material, and placing such a fabrication order with the fabricated object manufacturer 32, the following description of the function of the fabrication-order-receipt management control apparatus 14 will focus on the case of composite fabrication.

As illustrated in FIG. 6, a receiving unit 74 receives a fabrication request from various locations at the orderer including the media reader 26 and the ordering PC 28. As for the wording of the term “fabrication request”, this corresponds to “order placement” or “ordering” from the perspective of the orderer, whereas this corresponds to “order receipt” from the perspective of the receiving unit 74.

The receiving unit 74 is connected to a fabrication information extracting unit 76. The fabrication information extracting unit 76 extracts fabrication information from information about a fabrication request received by the receiving unit 74. Fabrication information includes fabrication format data, specified material, delivery time, and cost.

Desirably, the fabrication format data is voxel data saved in a fabricatable voxel (FAV) format.

Overview of FAV Format

The FAV format retains not only the outer structure of 3D model data but also information on a range of attributes such as those defining the internal structure, materials to be used, colors, and connection strength. The FAV format enables designers to design both the exterior and interior of 3D model data as desired, thoroughly down to the finest details in a precise and intricate manner, and then save this data.

The FAV format is constructed based on voxel data.

Voxels are the three-dimensional equivalents of pixel values. Similar to the way pixels as two-dimensional pixel values are arranged in a two-dimensional configuration to create an image, a three-dimensional fabricated object is structured by arranging voxels as three-dimensional pixel values in a three-dimensional configuration.

That is, the FAV format represents 3D model data satisfying the following conditions.

Condition 1: The information required for fabrication (e.g., shape, material, color, or connection strength) is clearly defined for each three-dimensional location, for both the exterior and interior of 3D model data.

Condition 2: The 3D model data allows the user to design (CAD), analyze (CAE), and inspect (CAT) the 3D model data seamlessly in an integrated and two-way manner without having to convert data.

As illustrated in FIG. 6, the fabrication information extracting unit 76 is connected to a fabricating-material-type identifying unit 78 and a fabrication method selecting unit 80.

The fabricating-material-type identifying unit 78 identifies the type of material to be used in fabrication. Fabrication requests according to the exemplary embodiment include a fabrication request for a three-dimensional fabricated object made from a single type of material, and a fabrication request (composite fabrication) for a fabricated object completed by assembling multiple three-dimensional fabricated objects made from multiple types of materials. The fabricating-material-type identifying unit 78 identifies a single or multiple types of materials, and sends the identified single or multiple types of materials to the fabrication method selecting unit 80.

The fabrication method selecting unit 80 is connected with a material/fabrication-method compatibility table memory 82, and a support-necessity determining unit 84.

The fabrication method selecting unit 80 checks the material type identified by the fabricating-material-type identifying unit 78 against the material/fabrication-method compatibility table read from the material/fabrication-method compatibility table memory 82, and selects a fabrication method that is compatible with the identified material type (see the three-dimensional fabricators 36A to 36G in FIGS. 3A to 3G). The ability of the FAV format to retain information about materials facilitates selection of a suitable fabrication method.

Further, based on fabrication format data received from the fabrication information extracting unit 76, for example, the fabrication method selecting unit 80 simulates mimicry of a three-dimensional fabricated object that will become a finished fabricated object, irrespective of whether the three-dimensional fabricated object is fabricated from a single material or a combination of multiple materials, and inquires the support-necessity determining unit 84 whether a support is required.

For example, suppose that an object is to be fabricated using two different kinds of materials. In this case, if the object to be fabricated includes a portion (overhang) such that the lower face of a component serving as an upper layer hangs over the upper face of a component serving as a lower layer underneath the upper layer, it is desired to fabricate a support to support the overhang. Accordingly, the support-necessity determining unit 84 illustrated in FIG. 6 determines, through mimicry of a three-dimensional fabricated object, whether there is an overhang, and whether a support is required based on the amount of projection of such an overhang.

In some instances, fabrication of a support requires the three-dimensional fabricator 36 to have, in addition to a fabrication head used for fabricating the target object to be fabricated, an auxiliary head used for fabricating the support.

As illustrated in FIG. 6, the fabrication method selecting unit 80 is connected with an operating information reading unit 86. The operating information reading unit 86 receives operating information from a fabricator management unit 88, which manages fabrication performed by the three-dimensional fabricators 36 owned by multiple fabricated object manufacturers 32 (multiple control apparatuses 34), and sends the received information to the fabrication method selecting unit 80.

Accordingly, in selecting a fabrication method based on whether an object is to be fabricated from a single material or multiple materials, the fabrication method selecting unit 80 selects a fabrication method (and the fabricated object manufacturer 32 to which a fabrication request is to be made) by taking into account, in addition to the material/fabrication-method compatibility table, information about delivery time and cost received from the fabrication information extracting unit 76, as well as information about the current operating condition of the three-dimensional fabricator 36 received from the operating information reading unit 86. The fabrication method selecting unit 80 then sends information indicative of the selected fabrication method to a fabrication workflow developing unit 90 and an order sheet creating unit 91, which each serve as a generator. Desirably, the fabricated object manufacturer 32 is selected by taking factors such as fabrication method, delivery time, and price into account in addition to operating information.

The fabrication workflow developing unit 90 develops, in particular, a procedure to be followed by the composite fabrication unit 40 in fabricating a finished fabricated object through assembly of fabricated objects (components) made from multiple materials.

At time time, the composite fabrication unit 40 performs fabrication through either a basic or irregular procedure. In the basic procedure, while sequentially moving the belt conveyor 38 in a one-way direction as indicated by the arrow A in FIGS. 4A and 4B to a position facing each three-dimensional fabricator 36, the composite fabrication unit 40 fabricates a new three-dimensional fabricated object on top of a three-dimensional fabricated object that has been previously fabricated. In the irregular procedure, the composite fabrication unit 40 performs fabrication while selecting different three-dimensional fabricators 36 in a complex manner.

Accordingly, the fabrication workflow developing unit 90 develops workflows N (N represents the number of steps) made up of multiple steps, including information such as the direction in which the belt conveyor 38 is moved in FIGS. 4A and 4B. The developed workflows N are sent to the order sheet creating unit 91.

The order sheet creating unit 91 creates an order sheet based on the fabrication method (and the fabricated object manufacturer 32) selected by the fabrication method selecting unit 80 and the workflows N developed by the fabrication workflow developing unit 90.

The order sheet creating unit 91, which is connected to a fabrication instructing unit 92 that functions as an instructing section, sends the created order sheet to the fabrication instructing unit 92.

As the fabrication instructing unit 92 instructs the fabricator management unit 88 to perform fabrication, the fabricator management unit 88 sends information related to the order sheet to the control apparatus 34 of the fabricated object manufacturer 32 that has been selected.

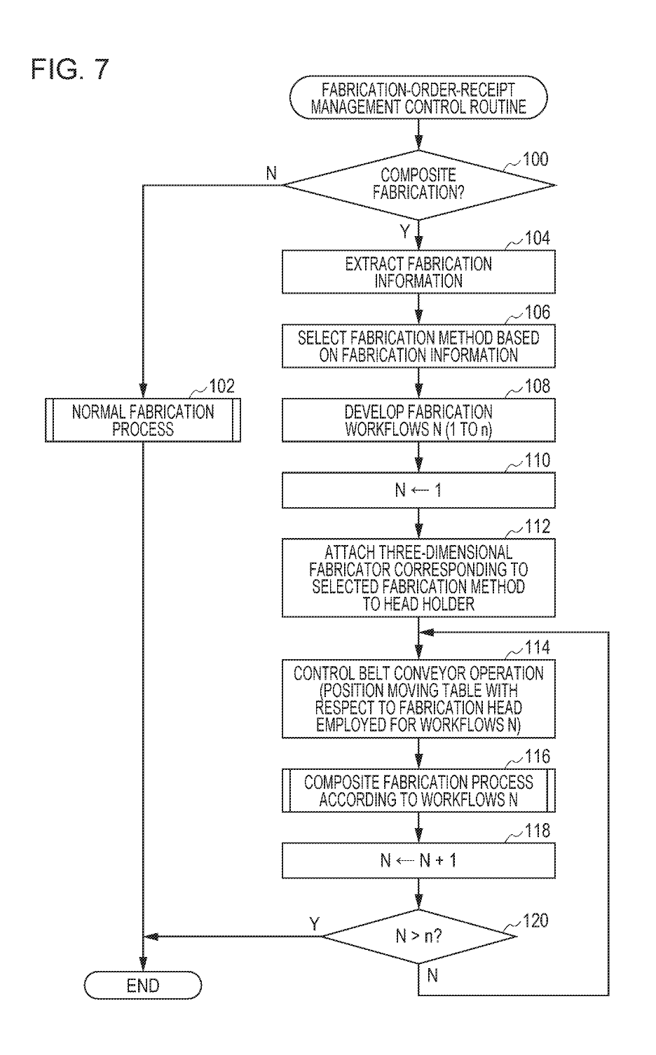

The operation of the exemplary embodiment will be described below with reference to the flowchart of FIG. 7.

FIG. 7 is a flowchart illustrating a fabrication-order-receipt management control routine executed by the fabrication-order-receipt management control apparatus 14 according to the exemplary embodiment upon receipt of a fabrication order.

At step 100, it is determined whether a received fabrication instruction is an instruction to fabricate a composite object. If the determination is negative, the process transfers to step 102 where a normal fabrication process is executed, and this routine is ended.

A normal fabrication process refers to a fabrication process that uses a single material and a single three-dimensional fabricator 36 to fabricate a three-dimensional fabricated object. A detailed description of this fabrication process is herein omitted.

If the determination at step 100 is affirmative, the process transfers to step 104 where fabrication information is extracted from the received fabrication request. Fabrication information includes at least the following items of information: fabrication format data, specified material, delivery time, and cost. It is assumed that as the specified material, a material is directly specified in some cases, whereas in some other cases the material is specified by its texture (such as surface gloss or hardness), outward appearance (such as transparency), or other features.

At the next step 106, the material/fabrication method compatibility table is read, and operating information on the three-dimensional fabricator 36 is read. Then, a fabrication method is selected by taking delivery time and cost into account. The process then transfers to step 108.

At step 108, the fabrication workflows N for performing composite fabrication are developed. That is, in the case of the composite fabrication unit 40 illustrated in FIGS. 4A and 4B, the three-dimensional fabricators 36 to be attached to the head holder 44, and the sequence of movement of the belt conveyor 38 are determined as multiple workflows (1 to n). Then, the composite fabrication unit 40 executes a process corresponding to each individual workflow in an orderly sequence.

At the next step 110, a variable N representing a number given to a workflow is set to 1. Then, the process transfers to step 112 where, as a preparatory process, the three-dimensional fabricator 36 corresponding to the selected fabricated method is attached to the head holder 44, and then the process transfers to step 114.

At step 114, operation of the belt conveyor 38 (moving table) is controlled. Specifically, each fabricating location on the belt conveyor 38 is so positioned as to face the corresponding three-dimensional fabricator 36 employed for the the workflows N (1 to n).

At the next step 116, a composite fabrication process is executed in accordance with a procedure indicated by the the workflows N, and then the process transfers to step 118.

At step 118, N is incremented (N←N+1). Then, at step 120, N and n are compared to determine whether N is greater than n. In the determination at step 120 is negative (Nn), it is determined that there are still remaining workflows N, and the process returns to step 114 to repeat the above-mentioned process.

If the determination at step 120 is affirmative (N≥n), it is determined that composite fabrication has finished, and this routine is ended.

The fabricated object manufacturer 32 delivers the finished three-dimensional fabricated object to the orderer. This completes the series of steps for fabricating the three-dimensional fabricated object.

Modification 1

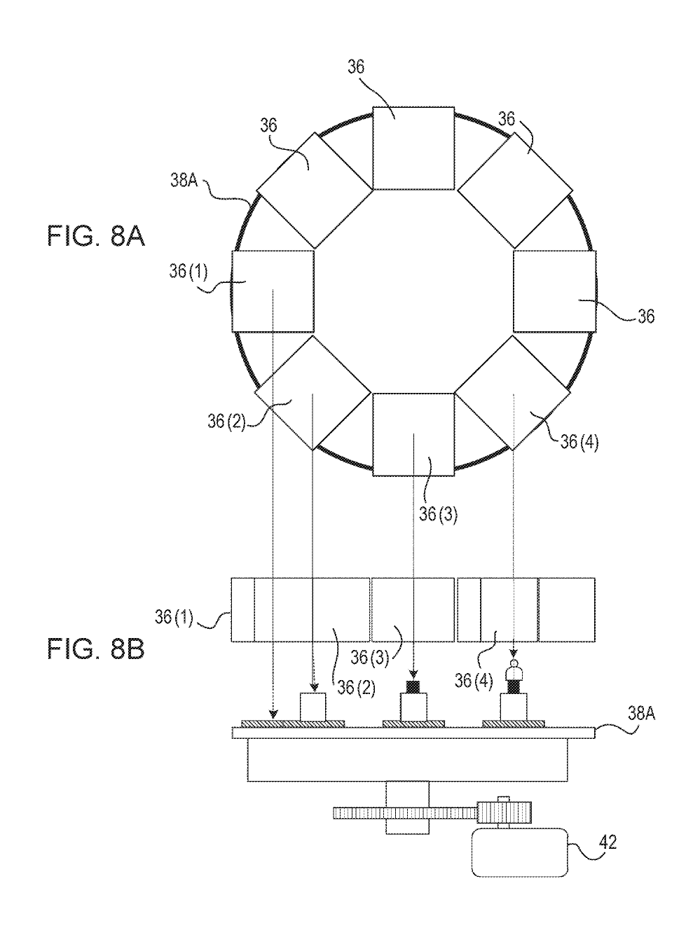

The foregoing description of the exemplary embodiment is directed to a composite fabrication system in which the belt conveyor 38 is moved, and based on an already-fabricated component fabricated prior to this movement, another component is fabricated by the three-dimensional fabricator 36 that exists at a location to which the belt conveyor 38 is moved. In an alternative exemplary embodiment, as illustrated in FIGS. 8A and 8B, a disc-shaped rotary table 38A is used instead of the belt conveyor 38, with multiple three-dimensional fabricators 36 disposed on the outer edges of the rotary table 38A such that as the rotary table 38A rotates, a required three-dimensional fabricator 36 is selected and positioned in place.

Modification 2

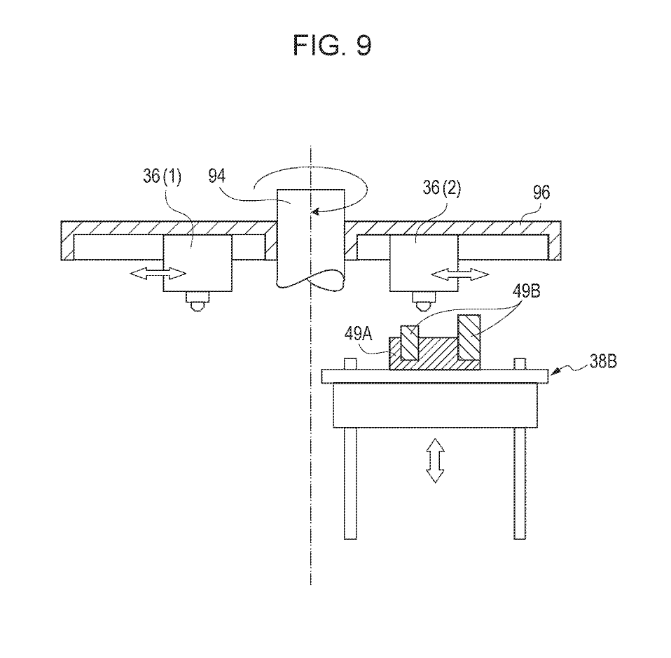

The foregoing description of the exemplary embodiment and Modification 1 is directed to a case where, as with each of the belt conveyor 38 serving as a table and the rotary table 38A, components 49A and 49B to be sequentially fabricated are moved. In an alternative exemplary embodiment, as illustrated in FIG. 9, a fabricator holder 96 that rotates on a rotating shaft 94 is disposed above a stationary table 38B, and as the fabricator holder 96 is rotated about the rotating shaft 94, different three-dimensional fabricators are selectively opposed to the stationary table 38B to fabricate the components 49A and 49B. FIG. 9 depicts an example in which the three-dimensional fabricator 36 (1) fabricates the component 49A, and the three-dimensional fabricator 36 (2) fabricates the component 49B.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fabrication management system comprising:
a fabrication control apparatus including
a composite fabrication unit that fabricates a fabricated component over a previously fabricated component to fabricate a finished fabricated object, and
a controller that controls fabrication performed by the composite fabrication unit; and
a fabrication management server including an instructing section that, by use of fabrication information about each of a plurality of fabricated components to be assembled into the finished fabricated object and positional information identifying a position onto which each fabricated component is assembled upon completion of the finished fabricated object, instructs fabrication to be performed by using the composite fabrication unit in accordance with fabrication procedure information used to sequentially perform fabrication in a height direction.

2. The fabrication management system according to claim 1,
wherein the fabrication control apparatus is placed in each of a plurality of fabricated object manufacturers, and
wherein the fabrication management server selects a fabricated object manufacturer by taking a fabrication method, delivery time, and price for each fabricated component into consideration in a comprehensive manner.

3. The fabrication management system according to claim 1,
wherein the composite fabrication unit includes
a holding section that holds, in a predetermined arrangement, a plurality of fabricators that employ different fabrication methods, and
a fabrication stage that supports a fabricated object fabricated by each of the fabricators, and
wherein the fabrication control apparatus moves at least one of the holding section and the fabrication stage in accordance with the fabrication procedure information to position a specific fabricator and the fabrication stage with respect to each other.

4. The fabrication management system according to claim 1,
wherein data that identifies each of the fabricated components comprises voxel data saved in a fabricatable voxel (FAV) format.

5. A fabrication management control apparatus comprising:
a generator that generates, for a composite fabrication unit that fabricates a fabricated component over a previously fabricated component to fabricate a finished fabricated object, fabrication procedure information used to sequentially perform fabrication in a height direction, by use of fabrication information about each of a plurality of fabricated components to be assembled into the finished fabricated object and positional information identifying a position onto which each fabricated component is assembled upon completion of the finished fabricated object; and
an instructing section that instructs a control apparatus that controls fabrication performed by the composited fabrication unit to perform fabrication in accordance with the fabrication procedure information by use of the composite fabrication unit.
